(19) United States
(12) Patent Application Publication
(10) Pub. No.: US 2012/0312604 A1
(43) Pub. Date: Dec. 13, 2012

(54) SEAT LOAD DETERMINATION DEVICE

(75) Inventor: Hiroyuki FUJII, Kariya-shi (JP)

(73) Assignee: AISIN SEIKI KABUSHIKI KAISHA, Kariya-shi (JP)

(21) Appl. No.: 13/494,205

(22) Filed: Jun. 12, 2012

(30) Foreign Application Priority Data
Jun. 13, 2011 (JP) 2011-131314

(51) Int. Cl. G01G 19/08

(52) U.S. Cl. 177/1; 177/136

(57) ABSTRACT

A seat load determination device includes a load sensor, which is provided at at least one of plural support portions supporting a seat, mounted to the support portion provided at one of right hand side and left hand side at the seat, and detecting a load applied to the support portion, a lateral acceleration correlation information determination portion detecting an information value having a positive correlation with a lateral acceleration which corresponds to an acceleration in a vehicle width direction as a lateral acceleration correlation information value, and determining whether an absolute value of the lateral acceleration correlation information value is equal to or less than a predetermined value, and a determination portion determining a seat load based on the load detected by the load sensor when the absolute value of the lateral acceleration correlation information value is equal to or less than the predetermined value.

### CROSS REFERENCE TO RELATED APPLICATIONS

This application is based on and claims priority under 35 U.S.C. §119 to Japanese Patent Application 2011-131314, filed on Jun. 13, 2011, the entire content of which is incorporated herein by reference.

### TECHNICAL FIELD

This disclosure generally relates to a seat load determination device.

### BACKGROUND DISCUSSION

In order to enhance performances of various safety devices, for example, airbags and seatbelts mounted to a vehicle, operations of the safety devices are controlled in accordance with a weight of an occupant that is seated in a seat according to known apparatuses. For example, when the occupant is seated in the seat without wearing a seatbelt, an alarm indicates that the seatbelt is unbuckled. Further, the law stipulates that a passenger-side airbag is to be deployed at a vehicle collision when an adult is seated in the passenger seat. The law further stipulates that a deployment of an airbag should be prohibited in a case where a child safety seat is fixed to the passenger seat facing backward, or a rear of the vehicle so that an infant or a child and a driver can see each other because an impact by the deployment of the airbag causes adverse effects. Under the law, a weight of a smaller female adult is applied as a criterion for determining whether an occupant is an adult. The law also stipulates a criterion for determining whether the child safety seat is fixed to the passenger seat. Thus, detecting a load applied to the seat to obtain a correct determination of a seat load, an occupancy state, or types of occupants is important to ensure a safety of the occupant.

A known seat load detection device, which measures a weight of an occupant, that is, a load applied to support portions of a seat, is disclosed in JP3904913B (Patent reference 1). According to the known seat load detection device, a load detection means which includes a strain gauge is provided between each of seat-side lower rails serving as the support portion of the seat and each of floor-side leg members so that the loads detected by the four load detection means are added to obtain the weight of the occupant. Known devices which detect a portion of the load by a load detection means which is provided at a part of support portions are adopted because the accurate load which is applied to all of the support portions is not necessarily measured for determining whether or not a passenger occupies a seat or whether an occupant is an adult or whether a child safety seat is fixed to a passenger seat.

For example, a known seat load determination device (passenger detection device) disclosed in JPH09-207638A (hereinafter referred to as Patent reference 2) is provided with load sensors mounted to two support portions among four support portions of a front right side, a front left side, a rear right side, and a rear left side, that is, the load sensors are provided at two portions at the front and rear at either one of a right hand side or a left hand side or the load sensors are provided at two portions at the front and rear arranged diagonally. A known seat load determination device disclosed in JP2011-16423A (hereinafter referred to as Patent reference 3) is provided with load sensors at two portions at the rear right side and the rear left side among the four support portions of the front right side, the front left side, the rear right side, and the rear left side. Thus, according to the known constructions, costs for parts and costs for assembling and wiring are reduced by the reduction of the quantity of the load sensors.

According to the known seat load determination devices disclosed, for example, in the Patent reference 2 and the Patent reference 3, which detect a part of the load applied to all of the support portions of the seat by arranging a load detection means to a part of the support portions, a distribution ratio of the load applied to the part of the support portions changes in response to changes of postures of an occupant and changes in positions of the occupant, and a detected load value varies. In order to prevent an erroneous determination of the load applied to the seat because of the variation of the detected load due to the changes of posture of the occupant and the changes in positions of the occupant, according to the Patent reference 2, the load values detected at two portions positioned at the front and rear portions are added, and an airbag is deployed only when a variable of the load value in a predetermined time is large. According to Patent reference 3, the load values detected at two portions at the right hand and left hand are added and whether an occupant is an adult or whether a child safety seat is fixed to a passenger seat is determined on the basis of an increment of the load value upon a start of a vehicle.

According to the construction of the known seat load determination devices disclosed in the Patent reference 2 and the Patent reference 3, which detects a part of the load applied to all of the support portions of the seat, a manufacturing cost is reduced, however, the detected load value is likely to vary depending on seated positions and postures of the occupant.

For example, according to the known seat load determination device disclosed in the Patent reference 2 for detecting the load applied to two of support portions each provided at front and rear sides, although a declination of a precision of the seat load determination can be prevented in a case where the posture of the occupant changes in front-rear directions, a countermeasure to prevent the declination of the precision of the seat load determination is necessary in a case where the posture of the occupant changes significantly in the right-left directions. Further, according to the known seat load determination device disclosed in the Patent reference 3 for detecting the load applied to two support portions provided at right and left sides, respectively, although a declination of a precision of the seat load determination can be prevented in a case where the posture of the occupant changes in right-left directions, a countermeasure is needed for the declination of the precision of the seat load determination in a case where the posture of the occupant changes significantly in front-rear directions.

Thus, according to the known seat load determination device for detecting a part of the load applied to all of the support portions of the seat, a mathematical operation is performed, for example, adding the load values detected at support portions, subtracting the load value detected at one of the support portions from the load value detected at the other of the support portions, or calculating a variable of the load value, for the purpose of preventing the declination of the precision of the seat load determination in response to the changes of postures of an occupant and changes in positions of the occupant.

A need thus exists for a seat load determination device, which is not susceptible to the drawback mentioned above.

### SUMMARY

In light of the foregoing, the disclosure provides a seat load determination device, which includes a load sensor provided at at least one of plural support portions supporting a seat for a vehicle, the load sensor mounted to the support portion provided at one of right hand side and left hand side at the seat among the plural support portions, the load sensor detecting a load applied to the support portion, a lateral acceleration correlation information determination portion detecting an information value having a positive correlation with a lateral acceleration which corresponds to an acceleration in a vehicle width direction as a lateral acceleration correlation information value, and determining whether an absolute value of the lateral acceleration correlation information value is equal to or less than a predetermined value, and a determination portion determining whether an adult passenger is seated in the seat or whether a child safety seat is fixed to the seat based on the load detected by the load sensor when the absolute value of the lateral acceleration correlation information value is equal to or less than the predetermined value.

According to another aspect of the disclosure, a method for a seat load determination includes steps of detecting an information value having a positive correlation with lateral acceleration which corresponds to acceleration in a vehicle width direction as a lateral acceleration correlation information value, determining whether an absolute value of the lateral acceleration correlation information value is equal to or less than a predetermined value, and determining whether an adult passenger is seated in a seat or whether a child safety seat is fixed to the seat on the basis of a load detected by a load sensor, which is provided at at least one of plural support portions supporting the seat for a vehicle, mounted to the support portion provided at one of right hand side or left hand side at the seat among the plural support portions, and detects a load applied to the support portion, when the absolute value of the lateral acceleration correlation information value is equal to or less than the predetermined value.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an explanatory view schematically showing a seat load determination device mounted to a vehicle according to a first embodiment disclosed here;

FIG. 2 is a block diagram showing a construction of the seat load determination device according to the first embodiment;

FIG. 3A is an explanatory view showing a state where a lateral acceleration is generated during a straight forward movement of a vehicle on a flat road surface;

FIG. 3B is an explanatory view showing a state where a lateral acceleration is generated during a turning movement of the vehicle to the right on a flat road surface;

FIG. 3C is an explanatory view showing a state where a lateral acceleration is generated during a turning movement of the vehicle to the left on a flat road surface;

FIG. 3D is an explanatory view showing a state where a lateral acceleration is generated during a straight forward movement of the vehicle on an inclined road surface which is inclined to the left;

FIG. 3E is an explanatory view showing a state where a lateral acceleration is generated during a straight forward movement of the vehicle on an inclined road surface which is inclined to the right;

FIG. 4 is a flowchart for a seat load determination according to the first embodiment disclosed here; and

FIG. 5 is a flowchart for a seat load determination according to a second embodiment disclosed here.

### DETAILED DESCRIPTION

Embodiments of a seat load determination device will be explained with reference to illustrations of drawing figures as follows. According to the embodiments, the seat load determination device performs a seat load determination, which determines a type of a load applying body (e.g., adult passenger, child safety seat), and a seat occupancy state (i.e., whether the seat is occupied or vacant).

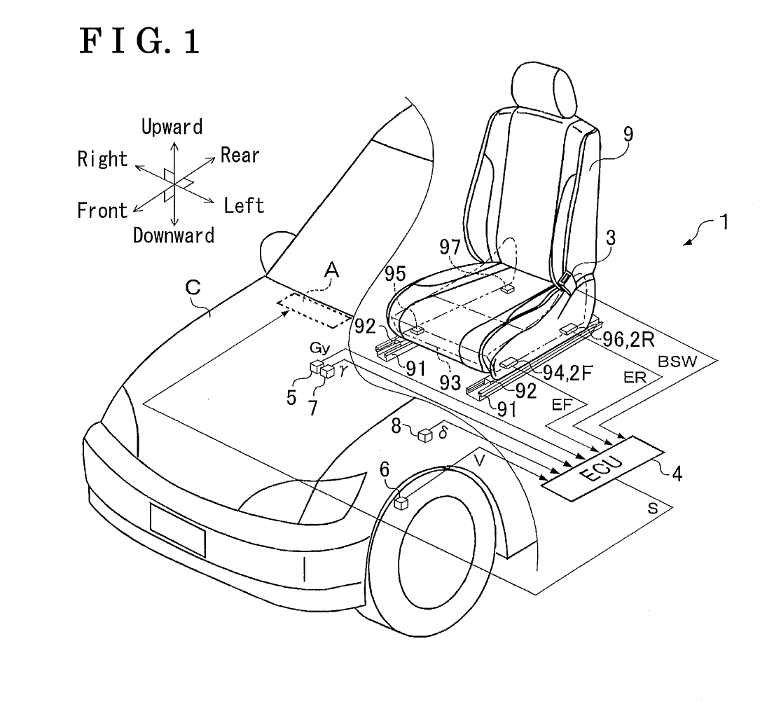

A construction of a seat load determination device 1 will be explained as follows. A left-hand drive vehicle is, for example, applied as a vehicle C shown in FIG. 1. FIG. 1 is a perspective view viewing the vehicle C from obliquely above for an explanatory purpose, and a roof portion of the vehicle is cut away for showing a passenger seat 9 which is an object for a seat load determination by the seat load determination device 1. A driver's seat is not shown in FIG. 1. The seat load determination device 1 performs a seat load determination determining a type of a load applying body, for example, an occupant seated in the seat 9, and a seat occupancy state. A deployment of an airbag A built-in a dashboard provided facing a passenger seat is controlled on the basis of a result of the determination. According to the embodiments, upward, downward, left, right, front, rear corresponds to upward, downward, left, right, front, rear indicated in FIG. 1.

The seat 9 is configured to move in front-rear directions by a slide mechanism which includes a pair of lower rails 91 and upper rails 92 extending in the front-rear direction of the vehicle C. A lower portion frame 93 which is covered with a cushion of the seat 9 is supported by the upper rail 92 via support portions 94-97 located at four corners of a bottom surface of the lower portion frame 93, respectively.

As shown in FIG. 1, the vehicle C includes a load determination ECU (electronic control unit) 4 provided either in an engine compartment or a vehicle compartment. Load sensors (e.g., front left and rear left load sensors) 2F, 2R provided at the seat 9 and a buckle switch 3 are connected to the load determination ECU 4. Further, a gravitational sensor (i.e., serving as a lateral acceleration detection portion) 5, a vehicle speed sensor (i.e., serving as a vehicle speed detection portion) 6, a yaw rate sensor (i.e., serving as a yaw rate detection portion) 7, and a steering angle sensor (i.e., serving as a steering angle detection portion) 8 are connected to the load determination ECU 4.

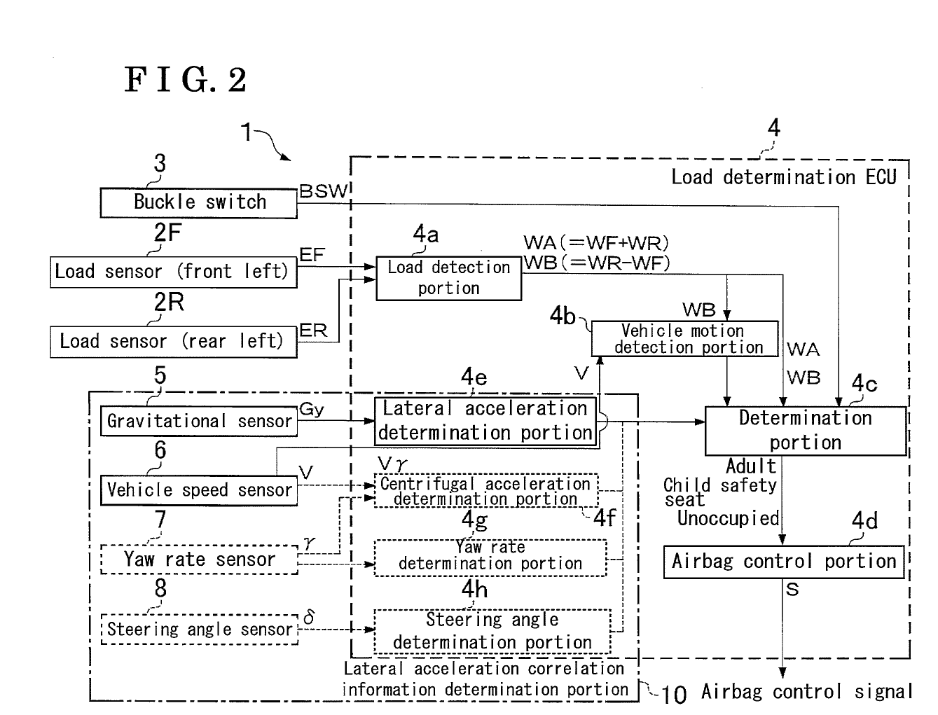

As shown in FIG. 2, the load determination ECU 4 includes a load detection portion 4a, a vehicle motion detection portion 4b, a determination portion 4c, an airbag control portion 4d, a lateral acceleration determination portion 4e, a centrifugal acceleration determination portion 4f, a yaw rate determination portion 4g, and a steering angle determination portion 4h.

According to the first embodiment, the seat load determination device 1 is structured with the load sensors 2F, 2R, the buckle switch 3, the gravitational sensor 5, the vehicle speed sensor 6, and the load detection portion 4a, the vehicle motion detection portion 4b, the determination portion 4c, the airbag control portion 4d, and the lateral acceleration determination portion 4e provided in the load determination ECU 4.

The load sensor 2F is provided at the support portion 94 positioned at a front left of the seat 9, and the load sensor 2R is provided at the support portion 96 positioned at a rear left of the seat 9. The support portions 95, 97 which are provided at the right hand side of the seat 9 apart from each other in the front-rear direction are structured to simply support the load. The load sensors 2F, 2R are strain gauge type sensors. Electric outputs EF, ER outputted from respective load sensors 2F, 2R are inputted into the load detection portion 4a of the load determination ECU 4.

The buckle switch 3 for detecting whether an occupant wears a seatbelt is provided within a buckle for attaching/detaching the seatbelt provided at the seat 9. Buckle information BSW outputted from the buckle switch 3 is inputted into the determination portion 4c of the load determination ECU 4.

The load determination ECU 4 is an electronic control unit which includes a calculation portion, a memory portion, an input portion, and an output portion and is operated by software. The load detection portion 4a, the vehicle motion detection portion 4b, the determination portion 4c, the airbag control portion 4d, and the lateral acceleration determination portion 4e provided in the load determination ECU 4 are realized mainly with software.

The gravitational sensor 5 is a sensor for detecting the acceleration acting on the vehicle C, and is configured to detect the acceleration Gx, Gy, Gz in three directions X, Y, Z. The gravitational sensor 5 is mounted to the vehicle C close to the center of the gravitation of the vehicle C in a state where the X-direction is oriented in a front-rear direction of the vehicle C, the Y direction is oriented in a vehicle width direction of the vehicle C, and the Z direction is oriented in an upward-downward direction of the vehicle C. The acceleration Gy directed in the Y direction corresponds to the lateral acceleration acting on the vehicle C, which serves as a lateral acceleration correlation information value. The lateral acceleration Gy includes the all lateral accelerations acting on the vehicle C due to the inclination of the vehicle body and the centrifugal force applied to the vehicle C irrespective of states of the vehicle whether the vehicle C is in motion (traveling state) or in a stopped state. The lateral acceleration Gy is inputted to the lateral acceleration determination portion 4e of the load determination ECU 4.

The vehicle speed sensor 6 is provided at each of right and left wheels of the vehicle C, and is configured to detect a vehicle speed V by detecting a rotational state of the wheels. The vehicle speed V is inputted into the vehicle motion detection portion 4b of the load determination ECU 4.

The load detection portion 4a provided at an input portion of the load determination ECU 4 includes an analog-to-digital converter (A/D converter), and is configured to obtain a load value WF (N or kgw) at front-left and a load value WR at rear-left (N or kgw) from the electric outputs EF, ER of the load sensors 2F, 2R applying a predetermined conversion equation. Then, the sum of load WA which is the sum of load values WF, WR and a load difference WB which is a difference between the load value WF and the load value WR are calculated and outputted by the load detection portion 4a. In those circumstances, the load detection portion 4a is activated at a predetermined sampling cycle, and performs a moving average in which the most recent plural raw data is equalized to output the sum of load WA and the load difference WB.

Here, zero point calibration of the load detection portion 4a, the load value WF, the load value WR, the sum of load WA, and the load difference WB is pre-performed. When performing the zero point calibration, a part of weight of the seat 9 acts on the load sensors 2F, 2R in a reference state where the vehicle C is not inclined and any load applying body is not provided on the seat 9. A level of the electric outputs EL, ER in those circumstances is adjusted to be zero. Alternatively, constants of conversion equation of the load detection portion 4a may be determined so that the load values WF, WR are assumed to be zero while the electric outputs EL, ER are not assumed to be zero. By performing the zero point calibration, the load value WF, the load value WR, the sum of load WA, and the load difference WB assume to correspond to a weight of the load applying body per se excluding the weight of the seat 9.

The vehicle motion detection portion 4b detects whether the vehicle C is in motion or is in a stopped state on the basis of the vehicle speed V outputted from the vehicle speed sensor 6 or on the basis of the load difference B outputted from the load detection portion 4a. The detection based on the vehicle speed V allows detecting that the vehicle is in motion when the vehicle speed V is outputted. On the other hand, the detection based on the load difference WB determines whether the vehicle C is in motion using the phenomenon that the load value WF at the front left reduces while the load value WR at the rear left increments to increase the load difference WB (i.e., WB=WR−WF) by the acceleration when the vehicle C in a stopped state starts moving. That is, it is determined that the vehicle C starts moving and is in motion when the load difference WB increments with a level equal to or greater than a predetermined level and with an increasing rate equal to or greater than a predetermined level for a predetermined time. The vehicle motion detection portion 4b outputs a detection result whether the vehicle C is in motion or in a stopped state to the determination portion 4c of the load determination ECU 4.

Whether the vehicle C is in motion or in the stopped state may be detected by other methods, for example, based on changes in the acceleration Gx in the front-rear direction of the vehicle C detected by the gravitational sensor 5, or based on a detection signal of an accelerator sensor.

The determination portion 4c compares the sum of load WA and the load difference WB outputted from the load detection portion 4a to each determination value, and compares a variable (change over time) of the sum of load WA and the load difference WB to each determination value, to determine whether the load applying body is an adult passenger (adult seated state) or whether the load applying body is a child safety seat at which the child safety seat is fixed to the seat 9 (child safety seat fixed state). A person having a weight greater than a small adult woman is defined as the adult. The child safety seat for retaining an infant, or child is fixed to the seat 9 by means of a seatbelt. Known methods (e.g., shown in the Patent reference 2 and Patent reference 3) for determining the types of load applying body are applicable, thus the explanations are omitted.

Because a precision of the seat load determination is enhanced by applying different values for each of the determination values of the sum of load WA and the load difference WB depending on the states of the vehicle C, that is, by applying different determination values during the vehicle C is in motion and during the vehicle is in the stopped state from one another, the determination portion 4c is configured to perform the seat load determination distinguishing whether the vehicle C is in motion or the vehicle C is in the stopped state.

The determination portion 4c outputs the determination results whether the load applying body is an adult passenger or a child safety seat to the airbag control portion 4d. This output is repeated by a predetermined cycle to renew the determination result. In those circumstances, when the determination results that the lateral acceleration Gy equal to or greater than a predetermined value (i.e., the large degree of the lateral acceleration Gy to some extent) acts on the vehicle C is outputted from the lateral acceleration determination portion 4e to the determination portion 4c, the determination portion 4c does not perform the seat load determination. In those circumstances, the determination result stored in the airbag control portion 4d is maintained without being renewed by the new determination results.

The airbag control portion 4d outputs an airbag control signal S upon receiving the determination result of the determination portion 4c to allow the deployment of the airbag A when the determination result indicates that the load applying body is an adult passenger in a case of vehicle collision (allowing deployment of the airbag A at collision) and prohibit the deployment of the airbag A when the determination result indicates that the load applying body is a child safety seat in a case of vehicle collision (prohibiting deployment of the airbag A at collision).

The lateral acceleration determination portion 4e determines whether an absolute value of the lateral acceleration Gy outputted from the gravitational sensor 5 is equal to or smaller than a predetermined value and outputs the determination results to the determination portion 4c. The lateral acceleration Gy is the information value having a positive correlation represented by correlation efficient of 1 (a perfect positive correlation) relative to the lateral acceleration which actually acts on the vehicle C, thus the lateral acceleration Gy corresponding to the lateral acceleration correlation information value. The gravitational sensor 5 and the lateral acceleration determination portion 4e serve as a lateral acceleration correlation information determination portion 10.

According to the construction of the embodiment, the lateral acceleration correlation information determination portion 10 provided at the seat load determination device 1 allows to eliminate the situations that accurate seat load determination cannot be performed. When the lateral acceleration Gy having a level greater than the predetermined value (i.e., greater level to some extent) acts on the vehicle C, the position and posture of an occupant seated in the seat 9 is changed and a distribution ratio of the load applied to right hand side and left hand side of the seat 9 at the support portions 94-97 of the seat 9 is likely to be changed.

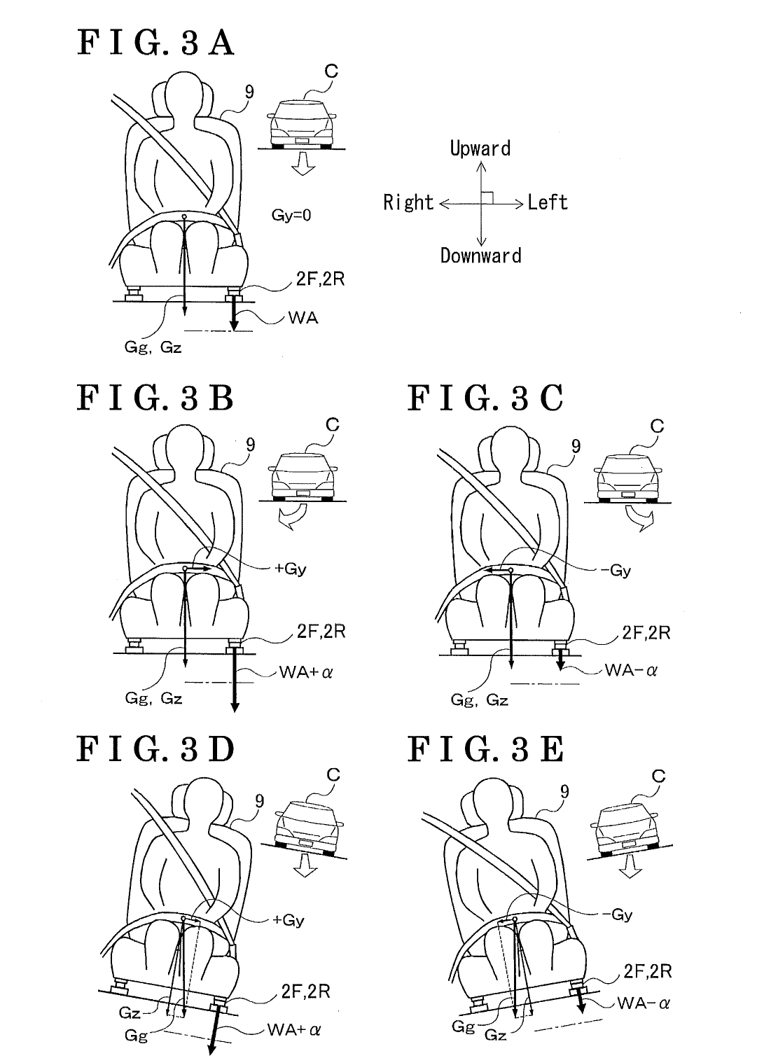

FIG. 3A shows a state where the vehicle C travels straight forward on a flat road surface. In those circumstances, the lateral acceleration Gy is zero (0), thus, unless an occupant seated in the seat 9 intentionally moves, the position and posture of the occupant does not change significantly. In those circumstances, the sum of load WA obtained by the outputs from the load sensors 2F 2R corresponds to approximately half (½) of a weight of the load applying body, for example, an occupant, or other nonhuman object. Thus, the seat load determination can be accurately performed based on the sum of load WA.

On the other hand, in a state where the lateral acceleration Gy is not zero (0) as shown in FIGS. 3B-3E, the distribution ratio to the right hand side and the left hand side of the seat 9 at the support portions 94-97 provided at the right hand side and left hand side of the seat 9 changes so that the sum of load WA increases (WA+α) or decreases (WA−α) compared to the state shown in FIG. 3A. Thus, when the lateral acceleration Gy has a level greater than the predetermined value (i.e., greater level to some extent), variations of an increase or decrease of the sum of load WA assume to be large and the seat load determination cannot be performed accurately on the basis of the sum of load WA.

As shown in FIG. 3B, in a state where the vehicle C turns to the right on a flat road surface, the sum of load WA increases in response to an increase of the lateral acceleration Gy in a positive direction (leftwards). As shown in FIG. 3C, in a state where the vehicle C turns to the left on a flat road surface, the sum of load WA decreases in response to a decrease of the lateral acceleration Gy in a negative direction (rightwards). As shown in FIG. 3D, in a state where the vehicle C travels straight forward on an inclined road surface which is inclined to the left, the sum of load WA increases in response to an increase of the lateral acceleration Gy serving as an inclination component which is obtained by the vector decomposition of a gravitational acceleration Gg in a positive direction (leftwards). As shown in FIG. 3E, in a state where the vehicle C travels straight forward on an inclined road surface which is inclined to the right, the sum of load WA decreases in response to an increase of the lateral acceleration Gy serving as an inclination component which is obtained by the vector decomposition of a gravitational acceleration Gg in a negative direction (rightwards).

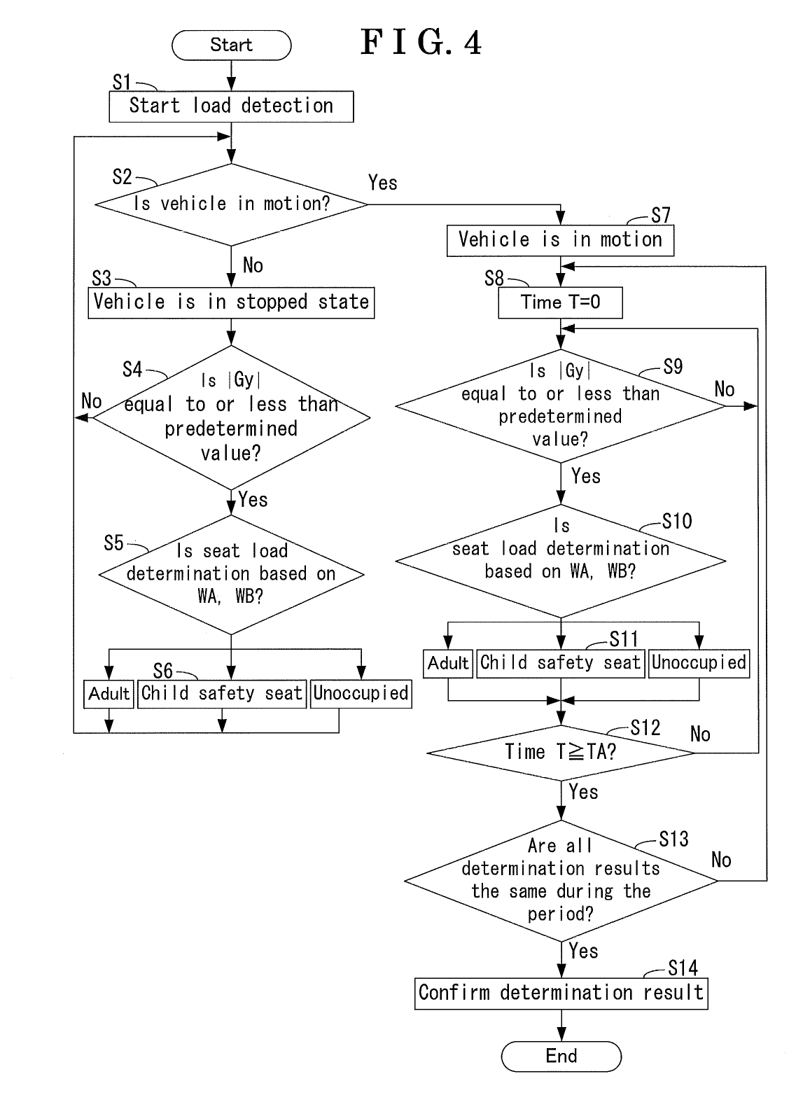

An operation of the seat load determination device 1 will be explained with reference to a flowchart for a seat load determination shown in FIG. 4. According to a seat load determination flow, first, an operation at the load determination ECU 4 starts upon turning an ignition switch on or upon buckling of a seatbelt to output the buckle information BSW. Next, at Step 51, the load sensors 2F, 2R output the electric outputs EF, ER, and the load detection portion 4a outputs the sum of load WA and the load difference WB obtained by applying the electric outputs EF, ER detected by the predetermined sampling cycle to the predetermined conversion equation.

At Step S2, the vehicle motion detection portion 4b detects whether the vehicle C is in motion or in a stopped state on the basis of the vehicle speed V outputted from the vehicle speed sensor 6 or the load difference WB outputted from the load detection portion 4a. Then, in a case where it is determined that the vehicle C is in the stopped state, the transaction is advanced to Step S4 via Step S3. Further, in a case where it is determined that the vehicle C is in motion, the transaction is advanced to Step S8 via Step S7.

In Step S4, the lateral acceleration determination portion 4e determines whether the absolute value of the lateral acceleration Gy outputted from the gravitational sensor 5 is equal to or less than the predetermined value, and when the absolute value of the lateral acceleration Gy is equal to or less than the predetermined value, the determination result is outputted to the determination portion 4c to advance the transaction to Step S5. Further, in a case where the absolute value of the lateral acceleration Gy is not equal to or less than the predetermined value, the transaction returns to Step S2 without outputting the determination result to the determination portion 4c.

In Step S5, the determination portion 4c compares the sum of load WA and the load difference WB outputted from the load detection portion 4a to each of the determination values, and/or compares the variable (change over time) of the sum of load WA and the load difference WB to each determination value. Then, in Step S6, whether the load applying body corresponds to an adult passenger, that is, whether an adult passenger is seated in the seat 9 (i.e., adult seated state) or the load applying body corresponds to a child safety seat in which the child safety seat is fixed to the seat 9 (i.e., child safety seat fixed state) is determined. In a case where the load applying body corresponds to neither adult passenger nor child safety seat, it is determined that the seat 9 is unoccupied (i.e., unoccupied state). After the seat load determination, the transaction returns to Step S2, then the execution of steps S2 to S6 is repeated until the vehicle C starts moving. In a case where the seat load determination result is changed while repeating the transaction of steps S2 to S6, the determination result is renewed.

Upon a start of the vehicle C, after resetting time T of a built-in timer at Step S8 so that time T is assumed to be zero (T=0), the transaction advances to Step S9. In Step S9, similar to Step S4, whether the absolute value of the lateral acceleration Gy is equal to or less than the predetermined value is determined. In a case where the absolute value of the lateral acceleration Gy is equal to or less than the predetermined value, the determination result is outputted to the determination portion 4c to advance the transaction to Step S10. In a case where the absolute value of the lateral acceleration Gy is not equal to or less than the predetermined value, the transaction of Step S9 is repeated without outputting the determination result to the determination portion 4c.

The transactions in Step S10 and Step S11 are similar to the transactions in Step S5 and Step S6, thus the explanation is omitted. After the occupancy state is determined in Step S11, that is, after determining whether an adult passenger corresponds to the load applying body, a child safety seat corresponds to the load applying body, or the seat 9 is not occupied by any load applying body in Step S11, the transaction advances to Step S12. In Step S12, it is examined whether time T has elapsed by a predetermined time TA (i.e., time T is equal to or longer than predetermined time TA), the transaction returns to Step S9 to repeat the determination transaction in a case where the predetermined time TA has not elapsed. In a case where the predetermined time TA has elapsed, the transaction advances to Step S13.

All of the results of the seat load determination during a period until the predetermined time TA elapses are stored in the determination portion 4c without renewing, and in Step S13, whether all of the determination results during the period until the predetermined time TA elapses are the same is determined. In a case where all of the determination results are the same, the determination result is confirmed in Step S14 to complete the operation. In a case where all of the determination results are not the same, it is determined that an occupant seated in the seat 9 intentionally moves significantly or the occupant moves from the seat 9 during the vehicle is in motion, thus returning the transaction to Step S8.

Irrespective of vehicle states, either vehicle is in motion or the vehicle is in a stopped state, the determination results whether the adult is seated in seat 9, the child safety seat is fixed to the seat 9, or the seat 9 is unoccupied is outputted to the airbag control portion 4d successively. The airbag control portion 4d outputs the airbag control signal S upon receiving the determination results to control the airbag A.

The necessity to deploy the airbag A is assumed to be greater during the vehicle C is in motion compared to the vehicle C is in a stopped state, thus erroneous determination of the seat load determination while the vehicle is in motion needs to be avoided as much as possible. In response to the foregoing, Step S13 is provided to more strictly confirm the determination results in a seat load determination flow when the vehicle C is in motion compared to the case where the vehicle C is in a stopped state. In those circumstances, the longer the predetermined TA is, the confirmation of the determination results becomes more strict, and when the predetermined time TA is assumed to be close to zero, renewed seat load determination result is outputted to the airbag control portion 4d successively likewise the case where the vehicle C is in the stopped state.

Effects and advantages attained by the construction of the seat load determination device 1 will be explained as follows. According to the construction of the embodiment, the load sensors 2F, 2R are provided at the support portions 94, 96, respectively, which are arranged on the left side among the plural support portions 94-97 for supporting the seat 9 of the vehicle C and are spaced apart from each other in the front-rear direction. The lateral acceleration Gy acting on the vehicle C is defined as the lateral acceleration correlation information value, and when the absolute value of the lateral acceleration Gy is equal to or less than the predetermined value, the seat load determination is performed on the basis of the load value WF, WR detected by the load sensors 2F, 2R. Namely, the seat load determination is not performed in a state where the lateral acceleration Gy equal to or greater than the predetermined value (i.e., in a state where the lateral acceleration Gy with large degree to some extent) acts on the vehicle C.

In a state where the lateral acceleration Gy equal to or greater than the predetermined value (i.e., in a state where the lateral acceleration Gy with large degree to some extent) acts on the vehicle C, the position and posture of the occupant seated in the seat 9 changes, thus the distribution ratio of the load applied to the right hand side and the left hand side of the seat 9 at the support portions 94-97 of the seat 9 is likely to be changed. In those circumstances, the seat load determination cannot be accurately performed based on the load values WF, WR detected by the load sensors 2F, 2R, respectively. According to the embodiment, a situation in which the seat load determination cannot be performed accurately can be eliminated as much as possible, and thus a declination of the precision for the seat load determination in response to the changes in the position and of the posture of the occupant seated in the seat 9 can be prevented.

Because the load sensors 2F, 2R are provided at the support portions 94, 96, respectively, which are arranged being spaced apart from each other in the front-rear direction, by the addition of the load values WF, WR detected at two portions, the declination of the precision for the seat load determination in response to the changes in the position and the posture, or attitude of the occupant and the seat 9 in the front-rear direction can be prevented. Accordingly, by combining the construction in which the seat load determination is not performed in a state where the lateral acceleration Gy acts on the vehicle C, the declination of the precision for seat load determination in response to the changes in the positions and postures of the occupant, for example, in the front-rear and right-left directions can be prevented.

According to the embodiment, the lateral acceleration correlation information determination portion 10 includes the gravitational sensor 5 detecting the lateral acceleration Gy of the vehicle C, and the lateral acceleration correlation information value is defined as the lateral acceleration Gy detected by the gravitational sensor 5. The lateral acceleration Gy detected by the gravitational sensor 5 includes all of the lateral acceleration acting on the vehicle C based on the centrifugal force applied to the vehicle C and an angle of inclination of the vehicle body irrespective of the states of the vehicle whether the vehicle C is in motion or the vehicle C is in the stopped state. Thus, according to the construction of the embodiment, because all of the lateral acceleration acting on the vehicle C can be detected exhaustively irrespective of whether the vehicle C is in motion or the vehicle C is in the stopped state, the effects to prevent the declination of the precision of the seat load determination in response to the changes in the positions and postures of the occupant seated in the seat 9 is enhanced.

A second embodiment of the seat load determination device will be explained with reference to FIGS. 1 and 2 as follows. Whereas the gravitational sensor 5 and the lateral acceleration determination portion 4e construct the lateral acceleration correlation information determination portion 10 according to the first embodiment, according to the second embodiment, the yaw rate sensor 7 and the yaw rate determination portion 4g construct the lateral acceleration correlation information determination portion 10. Other constructions are the same with the first embodiment, thus the explanation is not repeated.

The yaw rate sensor 7 is a sensor for detecting a yaw rate γ of the vehicle C (angular velocity of the vehicle body). The yaw rate sensor 7 is attached to the vicinity of the center of the gravity of the vehicle C, which is the approximately the same position where the gravitational sensor 5 is located, in a state where an axis of the yaw rate sensor 7 is arranged in the upward-downward direction of the vehicle C.

The yaw rate determination portion 4g provided in the load determination ECU 4 is configured to determine whether the absolute value of the yaw rate γ outputted from the yaw rate sensor 7 is equal to or less than a predetermined value, and outputs the determination results to the determination portion 4c.

As described above, the lateral acceleration acting on the vehicle C includes the centrifugal acceleration component in the vehicle width direction generated by the centrifugal force applied to the vehicle C during the turning of the vehicle C and the inclination component which is obtained by the vector decomposition of the gravitational acceleration Gg in the vehicle width direction in accordance with the inclination of the vehicle body relative to the horizontal state. The yaw rate γ generated by the turning operation of the vehicle C has a correlation with the centrifugal acceleration component included in the lateral acceleration.

Generally, considering that it is rare that the vehicle body inclines significantly to the degree affecting the position and posture of the occupant seated in the seat 9, in most of cases, disregarding the inclination component included in the lateral acceleration may be allowed. Based on the foregoing idea, the yaw rate γ generated by the turning operation of the vehicle C most likely includes a positive correlation with (positively correlated relative to) the lateral acceleration acting on the vehicle C.

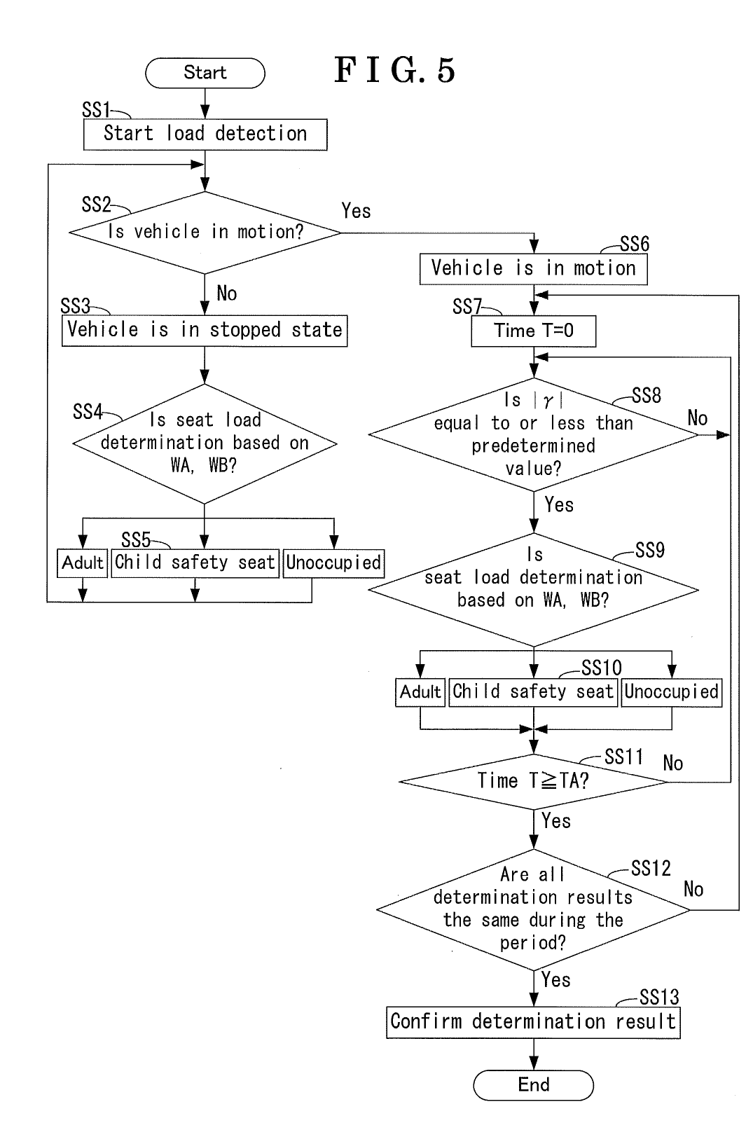

Next, the operation of the seat load determination device according to the second embodiment will be explained with reference to a flowchart for a seat load determination shown in FIG. 5. As explained above, because the yaw rate γ is generated by the turning operation of the vehicle C, according to the second embodiment, the lateral acceleration correlation information determination portion 10 functions only during the vehicle C is in motion. The flow for the seat load determination according to the second embodiment shown in FIG. 5 does not include a step corresponding to Step S4 in the flow for the seat load determination of the first embodiment shown in FIG. 4.

Steps SS1, SS2, SS3, SS4, SS5, SS6, SS7, SS9, SS10, SS11, SS12, and SS13 in the flow for the seat load determination according to the second embodiment correspond to Steps S1, S2, S3, S5, S6, S7, S8, S10, S11, S12, S13, and S14 in the flow for the seat load determination according to the first embodiment, respectively, thus the explanations are not repeated.

Whereas whether the absolute value of the lateral acceleration Gy outputted from the gravitational sensor 5 is equal to or less than the predetermined value is determined in Step S9 according to the first embodiment, whether the absolute value of the yaw rate γ outputted from the yaw rate sensor 7 is equal to or less than a predetermined value is determined in Step SS8 according to the second embodiment.

According to the construction of the second embodiment, the lateral acceleration correlation information determination portion 10 includes the yaw rate sensor 7 detecting the yaw rate γ of the vehicle C and the lateral acceleration correlation information value corresponds to the yaw rate γ detected by the yaw rate sensor 7.

As described above, in most of cases, disregarding the inclination component included in the lateral acceleration may be allowed. Based on the foregoing idea, the yaw rate γ generated by the turning operation of the vehicle C is most likely to have a positive correlation with (positively correlated relative to) the lateral acceleration acting on the vehicle C. Thus, according to the construction of the second embodiment, similar to the first embodiment, a situation that the accurate seat load determination cannot be performed can be eliminated as much as possible, and thus the declination of the precision for the seat load determination in response to the changes in the position and of the posture of the occupant seated in the seat 9 can be prevented.

Other embodiments will be explained as follows. The seat load determination device of the disclosure is not limited to the foregoing embodiments and may be varied.

For example, according to the first and second embodiments, the load sensors 2F, 2R are provided at the support portions 94, 96 provided spaced apart from each other in the front-rear direction for supporting the seat 9 of the vehicle C. However, according to the construction of the embodiment, because the declination of the precision for the seat load determination can be prevented irrespective of the number of the load sensors, the quantity of the load sensors mounted to the seat is not limited, for example, the number of the load sensors mounted to the seat may be one.

Further, according to the first and second embodiments, the load determination ECU 4 is configured to start upon the outputting of the buckle information BSW detected by the buckle switch 3. However, according to the alternative construction, the buckle switch 3 may not be provided.

Further, according to the first and second embodiments, the vehicle motion detection portion 4b is provided in the load determination ECU 4. Alternatively, the vehicle motion detection portion 4b may not be provided and the seat load determination may be performed by the determination portion 4c without distinguishing whether the vehicle C is in motion or the vehicle C is in the stopped state.

Further, according to the second embodiment, the lateral acceleration correlation information determination portion 10 is constructed by the yaw rate sensor 7 and the yaw rate determination portion 4g. However, the lateral acceleration correlation information value which has a correlation with the centrifugal acceleration component included in the lateral acceleration acting on the vehicle C is not limited to the yaw rate γ. For example, the lateral acceleration correlation information determination portion 10 may be constructed as follows.

For example, the lateral acceleration correlation information determination portion 10 may be constructed with the vehicle speed sensor (vehicle speed detection portion) 6, the yaw rate sensor (yaw rate detection portion) 7, and the centrifugal acceleration determination portion 4f provided in the load determination ECU 4 (see FIG. 2). In those circumstances, centrifugal acceleration Vγ calculated as the product of the vehicle speed V and the yaw rate γ may be defined as the lateral acceleration correlation information value and whether the absolute value of the centrifugal acceleration Vγ is equal to or less than a predetermined value may be determined by the centrifugal acceleration determination portion 4f. Because the centrifugal acceleration Vγ has a higher correlation with the lateral acceleration acting on the vehicle C compared to the yaw rate γ, according to this construction, effects for preventing the declination of the precision of the seat load determination can be enhanced compared to the construction disclosed in the second embodiment.

Alternatively, for example, the lateral acceleration correlation information determination portion 10 may be constructed with the steering angle sensor (steering angle detection portion) 8, and the steering angle determination portion 4h provided in the load determination ECU 4 (see FIG. 2). As shown in FIG. 1, the steering angle sensor 8 is configured to detect a steering angle δ of the vehicle C, and is mounted to a steering shaft. In those circumstances, the steering angle δ detected by the steering angle sensor 8 during the vehicle C is in motion may be defined as the lateral acceleration correlation information value, and whether the absolute value of the steering angle δ is equal to or less than a predetermined value may be determined by the steering angle determination portion 4h.

When a steering wheel of the vehicle C is operated by a greater angle during the vehicle is in motion, a significant level of the centrifugal force is applied to the vehicle C and the lateral acceleration acting on the vehicle C tends to be large. That is, the steering angle δ during the vehicle C is in motion is likely to have a positive correlation with the lateral acceleration acting on the vehicle C. Thus, according to the foregoing construction, similar to the second embodiment, the declination of the precision of the seat load determination can be prevented.

Considering that the greater level of the centrifugal force is applied to the vehicle C when the steering angle δ is greater and the vehicle speed V is faster, the product of the vehicle speed V and the steering angle δ has a high correlation with the centrifugal acceleration acting on the vehicle C. Thus, by applying the product of the vehicle speed V and the steering angle δ as the lateral acceleration correlation information value, the correlation of the lateral acceleration correlation information value with the lateral acceleration acting on the vehicle C is assumed to be higher compared to the case where the steering angle δ during the vehicle is in motion is defined as the lateral acceleration correlation information value, thus effects to prevent the declination of the precision of the seat load determination can be enhanced.

Further, plural (two or more than two) of each of means, or methods for lateral acceleration correlation information determination obtained by the lateral acceleration correlation information determination portion 10, that is, plural (two or more than two) of selections including the lateral acceleration Gy, the yaw rate γ, the centrifugal acceleration Vγ, and the steering angle δ as the lateral acceleration correlation information value may be combined. Combining the plural means, or methods for lateral acceleration correlation information determination obtained by the lateral acceleration correlation information determination portion 10 allows to integrate the above explained effects and advantages, thus contributing to enhance the precision for the seat load determination of the seat load determination device 1. Further, by combining the plural methods, or means for lateral acceleration correlation information determination (the lateral acceleration Gy, the yaw rate γ, the centrifugal acceleration Vγ, and the steering angle δ), even if a device, or an element for detecting one of the selected methods or means for lateral acceleration correlation information determination in the lateral acceleration correlation information determination portion 10 fails, a device, or an element for detecting another of selected methods or means for lateral acceleration correlation information determination in the lateral acceleration correlation information determination portion 10 operates normally, thus operational reliability of the seat load determination device 1 is enhanced.

According to the construction of the embodiment, a seat load determination device (1) includes a load sensor (2F, 2R) provided at at least one of plural support portions supporting the seat (9) for a vehicle, the load sensor (2F, 2R) mounted to the support portion (94, 96) provided at one of right hand side and left hand side at the seat among the plural support portions, the load sensor (2F, 2R) detecting a load applied to the support portion, a lateral acceleration correlation information determination portion (10) detecting an information value having a positive correlation with a lateral acceleration which corresponds to an acceleration in a vehicle width direction as a lateral acceleration correlation information value, and determining whether an absolute value of the lateral acceleration correlation information value is equal to or less than a predetermined value, and a determination portion (4c) determining whether an adult passenger is seated in the seat (9) or whether a child safety seat is fixed to the seat (9) on the basis of the load detected by the load sensor (2F, 2R) when the absolute value of the lateral acceleration correlation information value is equal to or less than the predetermined value.

According to the construction of the embodiment, the load sensor (2F, 2R) is provided at the support portion (94, 95, 96, 97) arranged at one of the right hand side or left hand side at the seat (9) among the plural support portions (94, 95, 96, 97) supporting the vehicle seat (9), and when the absolute value of the lateral acceleration correlation information value having a positive correlation with the lateral acceleration acting on the vehicle is equal to or less than the predetermined value, the seat load determination is performed on the basis of the load detected by the load sensor (2F, 2R). That is, the seat load determination is not performed in a state where the level of the lateral acceleration acting on the vehicle is equal to or greater than the predetermined value (in a state where the greater level of the lateral acceleration to some extent is applied to the vehicle).

When the lateral acceleration acts on the vehicle, a force directed towards an acting direction of the lateral acceleration acts on the vehicle C and an occupant. Thus, because a roll moment of inertia of the vehicle body is increased, and/or the occupant leans, or inclines towards the acting direction of the lateral acceleration or the occupant tries to maintain a vertical posture against the lateral acceleration, the position and the posture of the occupant seated in the seat 9 is changed, thus the distribution ratio of the load to the right hand and left hand at the support portions (94, 95, 96, 97) provided at the right side and left side of the seat (9) is assumed to be likely to change. Then, in a case where the level of the lateral acceleration reaches the predetermined value (in a case where the lateral acceleration is assumed to be greater to some extent), because a variable of the load detected by the load sensor (2F, 2R) provided at one of the right side and left side of the seat (9) is increased, an accurate seat load determination cannot be performed on the basis of the load detected by the load sensor.

According to the construction of the embodiment, the seat load determination is not performed in a state where the lateral acceleration equal to or greater than the predetermined value acts on the vehicle (in a state where the lateral acceleration which is greater to some extent is applied to the vehicle). This construction allows excluding a situation in which the accurate seat load determination cannot be performed, and thus the declination of the precision for the seat load determination in response to the changes in the position and of the posture of the occupant seated in the seat (9) can be prevented.

Further, according to the construction of the embodiment, the declination of the precision of the seat load determination can be prevented irrespective of the number of the load sensor provided at the one of the right side and the left side of the seat (9). Accordingly, the number of the load sensor provided at the seat is not limited.

According to the construction of the embodiment, the load sensor (2F, 2R) is provided at each of two of the plural support portions (94, 96) which are spaced apart from each other in a front-rear direction at one of the right hand side and left hand side of the seat (9).

According to the construction of the embodiment, the load sensor (2F, 2R) is provided at each of two support portions, which are spaced apart from each other in a front-rear direction at one of the right and left sides of the seat (9). Thus, according to the construction of the embodiment, the declination of the precision of the seat load determination in response to the changes in the position and of the posture of the occupant and the seat 9 in the front-rear direction can be prevented by adding the load values detected at two portions. Accordingly, by combining with the aforementioned other effects and advantages of the embodiment, the declination of the precision of the seat load determination in response to the position and posture, or attitude of the occupant in various directions including in the front-rear direction and right-left direction can be prevented.

According to the construction of the embodiment, the lateral acceleration correlation information determination portion (10) includes a lateral acceleration detection portion (gravitational sensor 5) detecting the lateral acceleration of the vehicle, and the lateral acceleration correlation information value corresponds to the lateral acceleration detected by the lateral acceleration detection portion (gravitational sensor 5).

According to the construction of the embodiment, the lateral acceleration correlation information determination portion (10) includes the lateral acceleration detection portion (5) detecting the lateral acceleration of the vehicle, and the lateral acceleration correlation information value corresponds to the lateral acceleration detected by the lateral acceleration detection portion (5). The lateral acceleration detected by the lateral acceleration detection portion, for example, the gravitational sensor (5) (i.e., lateral acceleration correlation information value) corresponds to all of the lateral accelerations acting on the vehicle irrespective of the vehicle states including when the vehicle C is in motion and when the vehicle C is in stopped state in accordance with the inclination of the vehicle body and the centrifugal force applied to the vehicle. Thus, according to the construction of the embodiment, because all of the lateral acceleration acting on the vehicle can be thoroughly detected irrespective of the vehicle states whether the vehicle is in motion or the vehicle is stopped, the effects for preventing the declination of the precision of the seat load determination in response to the changes in the position and the posture, or attitude of the occupant seated in the seat 9 is enhanced.

The lateral acceleration acting on the vehicle includes the centrifugal acceleration component in the vehicle width direction which is generated by the centrifugal force applied to the vehicle during the turning operation of the vehicle and the inclination component which is attained by the vector decomposition of the gravitational acceleration in the vehicle width direction in accordance with the level of the inclination relative to the horizontal of the vehicle body. The inclination of the vehicle body relative to the horizontal state is generated, for example, by a roll motion of the vehicle body by the centrifugal force applied to the vehicle, by a state where the vehicle is loaded so that one side is assumed to be heavy (in a case of unbalanced loaded state of the vehicle), and by a state where the vehicle travels on an inclined road surface (road surface having large cross grade, or transverse grade, that is, cross slope, or transverse slope).

According to the embodiment, the lateral acceleration correlation information determination portion (10) includes a vehicle speed detection portion (vehicles speed sensor 6) detecting a vehicle speed of the vehicle and a yaw rate detection portion (yaw rate sensor 7) detecting a yaw rate of the vehicle, and the lateral acceleration correlation information value corresponds to a centrifugal acceleration calculated as the product of the vehicle speed and the yaw rate.

According to the construction of the embodiment, the lateral acceleration acting on the vehicle includes the centrifugal acceleration component and the inclination component. The centrifugal acceleration calculated as the product of the vehicle speed and the yaw rate corresponds to the centrifugal acceleration component.

Generally, it is rare that the vehicle body inclines, or leans to the extent affecting the position and posture, or attitude of the occupant seated in the seat (9). Considering the foregoing, a state where the lateral acceleration having a large degree to some extent (i.e., the lateral acceleration greater and the predetermined level) is applied to the vehicle can be recognized even if only the centrifugal acceleration component (centrifugal acceleration) included in the lateral acceleration is used as the lateral acceleration correlation information value disregarding the inclination component included in the lateral acceleration. Thus, according to the foregoing construction, the declination of the precision of the seat load determination in response to the changes in the position and the posture, or attitude of the occupant seated in the seat (9) can be prevented.

According to the construction of the embodiment, the lateral acceleration correlation information determination portion (10) includes a yaw rate detection portion (yaw rate sensor 7) detecting a yaw rate of the vehicle, and the lateral acceleration correlation information value corresponds to the yaw rate detected by the yaw rate detection portion (yaw rate sensor 7).

A yaw rate corresponding to the rotational angular velocity of the vehicle body is generated when the vehicle turns. As described above, because the centrifugal acceleration component (centrifugal acceleration) included in the lateral acceleration acting on the vehicle is calculated as the product of the vehicle speed and the yaw rate, the yaw rate tends to have (is likely to have) a positive correlation with the lateral acceleration acting on the vehicle. Thus, according to the foregoing construction, the declination of the precision for the seat load determination in response to the changes in the position and posture, or attitude of the occupant seated in the seat 9 can be prevented.

According to the construction of the embodiment, the lateral acceleration correlation information determination portion (10) includes a steering angle detection portion (steering angle sensor 8) detecting a steering angle of the vehicle, and the lateral acceleration correlation information value corresponds to the steering angle detected by the steering angle detection portion (steering angle sensor 8) during the vehicle is in motion.

According to the construction of the embodiment, when a steering wheel of the vehicle is operated by a greater angle, for example, when the vehicle makes a sharp turn or turning to the right or left, a large degree of the centrifugal force is applied to the vehicle, and thus the lateral acceleration acting on the vehicle is likely to be large degree. Namely, the steering angle during the vehicle is in motion is most likely to have (tends to have) a positive correlation with (relative to) the lateral acceleration acting on the vehicle. Thus, according to the foregoing construction, the declination of the precision of the seat load determination in response to the changes in the position and posture, or attitude of the occupant seated in the seat (9) can be prevented.

The greater the steering angle and the vehicle speed is, the greater centrifugal force applied to the vehicle becomes. As explained above, considering that the product of the vehicle speed and the yaw rate corresponds to the centrifugal acceleration applied to the vehicle, the product of the vehicle speed and the steering angle has a high correlation with the centrifugal acceleration acting on the vehicle. Thus, by applying the product of the vehicle speed and the steering angle as the lateral acceleration correlation information value, because a correlation of the lateral acceleration acting on the vehicle and the lateral acceleration correlation information value is assumed to be higher, the declination of the precision for the seat load determination can be further enhanced.

According to the construction of the embodiment, the lateral acceleration correlation information determination portion (10) includes a vehicle speed detection portion (vehicle speed sensor 6) detecting a vehicle speed of the vehicle and a steering angle detection portion (steering angle sensor 8) detecting a steering angle of the vehicle, and the lateral acceleration correlation information value corresponds to the product of the vehicle speed detected by the vehicle speed detection portion (vehicle speed sensor 6) and the steering angle detected by the steering angle detection portion (steering angle sensor 8).

According to the construction of the embodiment, equal to or more than two of selections including the lateral acceleration detected by a lateral acceleration detection portion, a centrifugal acceleration calculated as the product of a vehicle speed V detected by a vehicle speed detection portion (vehicle speed sensor 6) and a yaw rate γ detected by a yaw rate detection portion (yaw rate sensor 7), a yaw rate γ detected by a yaw rate detection portion (yaw rate sensor 7), a steering angle δ detected by a steering angle detection portion (steering angle sensor 8) during a vehicle is in motion, and the product of a vehicle speed V detected by a vehicle speed detection portion (vehicle speed sensor 6) during a vehicle is in motion and a steering angle δ detected by a steering angle detection portion (steering angle sensor 8) are selected as the lateral acceleration correlation information value.

According to the construction of the embodiment, combining the plural methods, or means for lateral acceleration correlation information determination obtained by the lateral acceleration correlation information determination portion (10) results in integrating the above-explained effects, thus contributing to enhance the precision of the seat load determination of the seat load determination device (1). Further, by combining the plural methods, or means for lateral acceleration correlation information determination obtained by the lateral acceleration correlation information determination portion (10), even if one of the selected methods or means for lateral acceleration correlation information determination to be obtained by the lateral acceleration correlation information determination portion (10) is failed to be obtained, another of selected methods or means for lateral acceleration correlation information determination obtained by the lateral acceleration correlation information determination portion (10) is obtained normally, thus operational credibility of the seat load determination device is enhanced.

In many (most) of cases (vehicles), the lateral acceleration detection portion, for example, the gravitational sensor (5), the vehicle speed detection portion, for example, the vehicle speed sensor (6), the yaw rate detection portion, for example, the yaw rate sensor (7), the steering angle detection portion, for example, the steering angle sensor (8) are mounted to the vehicle, thus the possibility for the necessity to additionally provide a detector exclusively for detecting the lateral acceleration acting on the vehicle is low. Accordingly, the possibility that manufacturing costs and costs of parts are assumed to be problem for providing the seat load determination device to the vehicle is low.

As explained above, with the construction of the seat load determination device (1) detecting a part of the load applied to all of the support portions (94, 95, 96, 97) of the seat (9) of the embodiment, the declination of the precision of the seat load determination in response to the changes in the position and posture, or attitude of the occupant seated in the seat (9) can be prevented.

According to the construction of the seat load determination device (1) for determining whether an adult passenger occupies the seat or a child safety seat is fixed to the seat by detecting a part of the load applied to all of the support portions of the seat of the embodiment, the declination of the precision of the seat load determination in response to the changes in the position and posture, or attitude of the occupant seated in the seat (9) can be prevented.

According to the construction of the embodiment, the seat load determination device (1) further includes a vehicle motion detection portion (4b) detecting whether the vehicle is in motion. The determination portion (4c) confirms the determination result when the determination result is the same for a predetermined time in a case where the vehicle motion detection portion (4b) detects that the vehicle is in motion.

According to the embodiment, a method for a seat load determination, includes steps of detecting an information value having a positive correlation with lateral acceleration which corresponds to acceleration in a vehicle width direction as a lateral acceleration correlation information value, determining whether an absolute value of the lateral acceleration correlation information value is equal to or less than a predetermined value, and determining whether an adult passenger is seated in a seat (9) or whether a child safety seat is fixed to the seat (9) on the basis of a load detected by a load sensor (2F, 2R), which is provided at at least one of plural support portions (94, 95, 96, 97) supporting the seat (9) for a vehicle, mounted to the support portion provided at one of right hand side or left hand side at the seat among the plural support portions, and detects a load applied to the support portion, when the absolute value of the lateral acceleration correlation information value is equal to or less than the predetermined value.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat load determination device, comprising:
a load sensor provided at at least one of plural support portions supporting a seat for a vehicle, the load sensor mounted to the support portion provided at one of right hand side and left hand side at the seat among the plural support portions, the load sensor detecting a load applied to the support portion;
a lateral acceleration correlation information determination portion detecting an information value having a positive correlation with a lateral acceleration which corresponds to an acceleration in a vehicle width direction as a lateral acceleration correlation information value, and determining whether an absolute value of the lateral acceleration correlation information value is equal to or less than a predetermined value; and
a determination portion determining whether an adult passenger is seated in the seat or whether a child safety seat is fixed to the seat based on the load detected by the load sensor when the absolute value of the lateral acceleration correlation information value is equal to or less than the predetermined value.

2. The seat load determination device according to claim 1, wherein the load sensor is provided at each of two of the plural support portions which are spaced apart from each other in a front-rear direction at one of the right hand side and left hand side of the seat.

3. The seat load determination device according to claim 1, wherein the lateral acceleration correlation information determination portion includes a lateral acceleration detection portion detecting the lateral acceleration of the vehicle, and the lateral acceleration correlation information value corresponds to the lateral acceleration detected by the lateral acceleration detection portion.

4. The seat load determination device according to claim 1, wherein the lateral acceleration correlation information determination portion includes a vehicle speed detection portion detecting a vehicle speed of the vehicle and a yaw rate detection portion detecting a yaw rate of the vehicle, and the lateral acceleration correlation information value corresponds to a centrifugal acceleration calculated as a product of the vehicle speed and the yaw rate.

5. The seat load determination device according to claim 1, wherein the lateral acceleration correlation information determination portion includes a yaw rate detection portion detecting a yaw rate of the vehicle, and the lateral acceleration correlation information value corresponds to the yaw rate detected by the yaw rate detection portion.

6. The seat load determination device according to claim 1, wherein the lateral acceleration correlation information determination portion includes a steering angle detection portion detecting a steering angle of the vehicle, and the lateral acceleration correlation information value corresponds to the steering angle detected by the steering angle detection portion during the vehicle is in motion.

7. The seat load determination device according to claim 1, wherein the lateral acceleration correlation information determination portion includes a vehicle speed detection portion detecting a vehicle speed of the vehicle and a steering angle detection portion detecting a steering angle of the vehicle, and the lateral acceleration correlation information value corresponds to a product of the vehicle speed detected by the vehicle speed detection portion and the steering angle detected by the steering angle detection portion.

8. The seat load determination device according to claim 1, wherein equal to or more than two of selections including the lateral acceleration detected by a lateral acceleration detection portion, a centrifugal acceleration calculated as a product of a vehicle speed detected by a vehicle speed detection portion and a yaw rate detected by a yaw rate detection portion, a yaw rate detected by a yaw rate detection portion, a steering angle detected by a steering angle detection portion during a vehicle is in motion, and a product of a vehicle speed detected by a vehicle speed detection portion during a vehicle is in motion and a steering angle detected by a steering angle detection portion are selected as the lateral acceleration correlation information value.

9. The seat load determination device according to claim 1 further comprising:
a vehicle motion detection portion detecting whether the vehicle is in motion; wherein the determination portion confirms the determination result when the determination result is the same for a predetermined time in a case where the vehicle motion detection portion detects that the vehicle is in motion.

10. A method for a seat load determination, comprising steps of:
detecting an information value having a positive correlation with lateral acceleration which corresponds to acceleration in a vehicle width direction as a lateral acceleration correlation information value;
determining whether an absolute value of the lateral acceleration correlation information value is equal to or less than a predetermined value; and
determining whether an adult passenger is seated in a seat or whether a child safety seat is fixed to the seat on the basis of a load detected by a load sensor, which is provided at at least one of plural support portions supporting the seat for a vehicle, mounted to the support portion provided at one of right hand side or left hand side at the seat among the plural support portions, and detects a load applied to the support portion, when the absolute value of the lateral acceleration correlation information value is equal to or less than the predetermined value.
